(19) United States
(12) Patent Application Publication
(10) Pub. No.: US 2012/0270063 A1
(43) Pub. Date: Oct. 25, 2012

(54) Thermal Barrier Coating Having Low Thermal Conductivity

(76) Inventors: Alessandro Casu, Duisburg (DE); Anand A. Kulkarni, Oviedo, FL (US); Stefan Lampenscherf, Poing (DE)

(21) Appl. No.: 13/518,449

(22) PCT Filed: Jul. 2, 2010
(86) PCT No.: PCT/EP2010/059451

§ 371 Date: Jun. 22, 2012

(30) Foreign Application Priority Data
Dec. 23, 2009 (EP) 09015946.8

(51) Int. Cl. B32B 3/26; B05D 7/14

(52) U.S. Cl. 428/613; 427/180; 428/312.8

(57) ABSTRACT

A metallic article adapted to be exposed to a gas during operation conditions is provided. The metallic article includes a metallic substrate, and a thermal barrier coating on the metallic substrate for restricting heat transfer from the gas to the metallic substrate. The thermal barrier coating includes a coating of a ceramic material formed by a deposition of powdered particles of said ceramic material defining a porous microstructure, wherein the porous microstructure has an average pore size ‘d’, such that

$$d \leq 0.001 \cdot \frac{T}{p} ,$$

where d is the average pore size in μm, T is an absolute temperature of the gas, and P is a pressure of gas in atmospheres

### CROSS REFERENCE TO RELATED APPLICATIONS

This application is the US National Stage of International Application No. PCT/EP2010/059451, filed Jul. 2, 2010 and claims the benefit thereof. The International Application claims the benefits of European Patent Office application No. 09015946.8 EP filed Dec. 23, 2009. All of the applications are incorporated by reference herein in their entirety.

### FIELD OF INVENTION

The present invention relates generally to the field of thermal barrier coatings that are used in elevated temperature applications such as industrial gas turbines. In particular, this invention relates to a thermal insulating ceramic coating which has a low thermal conductivity and to the metallic articles, such as turbine components, to which the coatings are applied to prevent the components from overheating during high temperature operation.

### BACKGROUND OF INVENTION

Certain applications require metallic components to be exposed to hot gases at elevated temperatures. One such example is a gas turbine. In gas turbines, thermal carrier coatings (TBC) have been provided on metallic components, for example first and second rows of turbine blades and vanes, as well as combustor chamber components such as baskets, inserts, etc. exposed to the hot gas path. While the primary purpose of TBCs has been to extend the life of the coated components, advanced industrial gas turbines utilize TBCs more and more to allow for increases in efficiency and power output of the gas turbine. One measure to improve efficiency and power output is to reduce the cooling air consumption of the components in the hot gas path, i.e. by allowing those components to be operated at higher temperatures. The push to higher firing temperatures and reduced cooling flows generates an on-going demand for advanced TBCs with higher temperature stability and better thermal insulation to achieve long term efficiency and performance goals of advanced industrial gas turbines.

A TBC is generally formed of multiple layers over the metallic substrate to be protected, wherein at least one layer, typically the outer layer, is formed of a ceramic coating. This outer ceramic layer provides benefits in performance, efficiency and durability through a) increased engine operating temperature; b) extended metallic component lifetime when subjected to elevated temperature and stress; and c) reduced cooling requirements for the metallic components. Depending on the ceramic layer thickness and through thickness heat flux, the temperature of the substrate may be reduced by several hundred degrees.

The ceramic layer may be formed by any of several known processes, such as air plasma spray (APS) and electron beam-physical vapor deposition (EB-PVD), among others. Although coatings from these processes have the same chemical composition, their microstructures are fundamentally different from each other and so are their thermal insulation properties and performance. Improvement of the thermal insulation of the TBC can be achieved by increasing the TBC thickness, by using materials with lower bulk thermal conductivity or by modification of the TBC microstructure (e.g. porosity). However, so far, TBC microstructures have been optimized to reduce heat flow only through the solid phase of the porous TBC.

### SUMMARY OF INVENTION

The object of the present invention is to provide a TBC with a ceramic layer having a suitable microstructure to reduce heat flow through the TBC, particularly through the gas phase of the microstructure, i.e., through the gas in the pores of the ceramic microstructure.

The above object is achieved by a metallic article of claim having a thermal barrier coating in accordance with the claims, and a method for forming a thermal barrier coating in accordance with the claims.

The underlying idea of the present invention is to provide a thermal barrier coating with an optimized microstructure to reduce heat conduction, particularly conduction through the gaseous phase of the ceramic microstructure. This is achieved by reducing the pore size of the microstructure in accordance with the above-mentioned patent claims. The thermal conductivity of the gas phase of the microstructure increases with increase in pressure of the bulk gas. By reducing the pore size as mentioned above, the effect of pressure on the heat conduction through the gas phase is significantly reduced.

In one embodiment, said article is a gas turbine component. The present invention is particularly advantageous for gas turbine applications because under typical gas turbine operating temperatures and pressures, heat conduction through the gas phase of the microstructure is significant with respect to the heat conduction through the solid phase.

In an exemplary embodiment, said average pore size is equal to or less than 0.1 μm. A pore size in the mentioned range provides higher efficiency and performance goals of advanced industrial gas turbines. Further, as indicated experiments, a reduced pore size in the nanometers range (i.e., less than 0.1 μm.) allows an additional increase of the overall porosity of the TBC without compromising mechanical integrity of the TBC. This additional porosity increase reduces the heat flow through the solid phase of the TBC, and, therefore, provides an additional improvement of the thermal insulation of the TBC.

In one embodiment, the ceramic material comprises yttria stabilized zirconia. This provides increased protection against thermo-mechanical shock, high-temperature oxidation and hot corrosion degradation.

In a preferred embodiment, in order to achieve the desired pore size distribution, said powered particles have a particle size less than 0.5 μm.

In a further embodiment, said thermal barrier coating further includes an oxidation resistant metallic layer deposited directly on to said metallic substrate previous to forming said coating of said ceramic material. Advantageously, this metallic layer provides the physical and chemical bond between the ceramic coating and the metallic substrate and serves as an oxidation and corrosion resistance.

### BRIEF DESCRIPTION OF THE DRAWINGS

The present invention is further described hereinafter with reference to illustrated embodiments shown in the accompanying drawings, in which:

FIG. 1 is a cross-sectional view illustrating a metallic article having a thermal barrier coating (TBC) in accordance with an embodiment of the present invention, and

FIG. 2 is a graph illustrating variation of thermal diffusivity of a typical air plasma spray TBC in vacuum and in 1 atmosphere pressure air (nitrogen).

Embodiments of the present invention described herein below provide a thermal barrier coating (TBC) having a ceramic layer having an optimized microstructure that reduces heat conduction through the gas phase of the ceramic microstructure. Embodiments of the present invention are particularly advantageous in case of TBCs for gas turbine components, such as blades, vanes, combustors, baskets, inserts and so on. This is because the inventive idea is based on the finding that under typical gas turbine operation conditions (for example, temperatures higher than 1000° C. and pressure greater than 10 atmospheres) the hot gas contributes substantially to the heat flow across the TBC by conduction through the gas phase in the porous TBC.

### DETAILED DESCRIPTION OF INVENTION

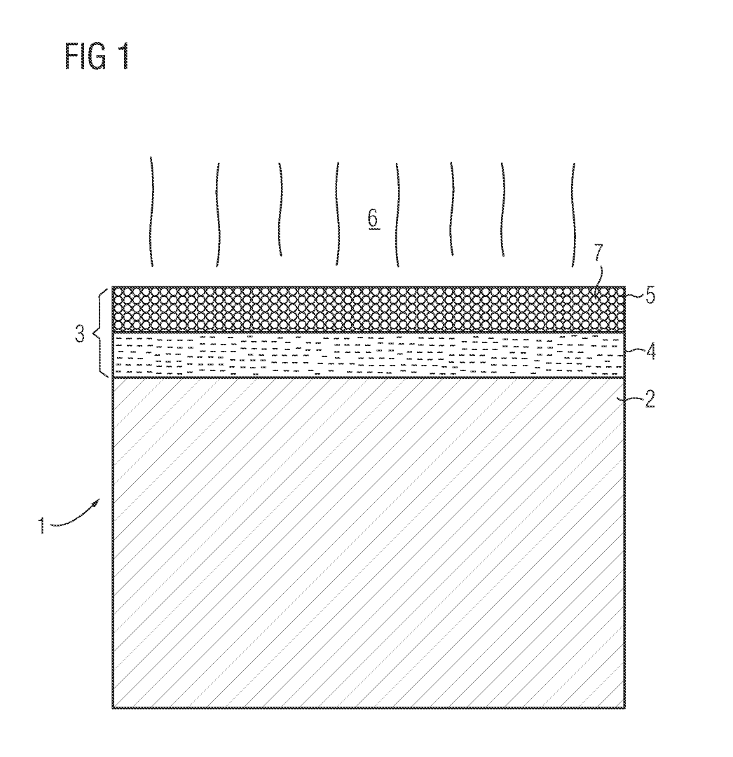

Referring to FIG. 1 is illustrated a cross-sectional view of a metallic article 1 adapted to be exposed to a hot gas 6. In the illustrated example, the metallic article 1 includes any gas turbine component as mentioned above, and the hot gas 6 comprises air. The article has a metallic substrate 2, which may include, for example, a nickel based high temperature alloy or superalloy. A thermal barrier coating 2 is formed on the substrate 2, to restrict heat transfer from the gas 6 to the substrate 2. This allows the substrate 2 to be maintained at a temperature much lower than that of the gas 6, which extends the life of the component 1 (or “article 1”, as used herein), while allowing higher operating temperatures.

In the illustrated embodiment, the TBC 3 comprises two layers, namely, an outer insulating ceramic layer 5 and an underlying oxidation resistant metallic layer 4. The metallic layer 4, also known as bond coat, is formed directly over the substrate 2 previous to forming of the ceramic coating 5. The bond coat 4 provides the physical and chemical bond between the ceramic coating 5 and the substrate 2 and additionally serves to provide oxidation and corrosion resistance by forming a slow growing adherent protective Alumina scale over the substrate 2. The ceramic coat 5, also referred to as top coat, comprises powdered particles 7 of a ceramic material, preferably yttria stabilized zirconia (YSZ) deposited on to the bond coat 4. The powdered ceramic particles 7 are deposited so to define a porous microstructure. For example, the powdered ceramic particles may be deposited by a process of air plasma spray (APS), solution plasma spray (SPS or SPPS) or electron beam-physical vapor deposition (EB-PVD), or any other known process.

In accordance with the inventive principle, thermal insulation by the ceramic coat 5 of the TBC 3 is improved by reducing the pore size of the microstructure of the ceramic coat 5 to the order of magnitude of the mean free path of the bulk gas 6 under operation conditions of the gas turbine. The pre size may be characterized, for example, by the pore diameter. It is found herein that the thermal conductivity of the gas phase in the porous ceramic layer 4 depends on mean free path of the bulk gas 6 and pore size d according to the relationship (1) below:

$$\frac{κ}{{κ}_{B}} ∝ {( 1 + c \cdot \frac{λ}{d} )}^{- 1} , \qquad ( 1 )$$

where κ is the thermal conductivity of the gas in the porous microstructure,
κ_{B} is the thermal conductivity of the bulk gas 6,
d is the average pore size of the microstructure in μm,
λ is the mean free path of the bulk gas 6, and
C is a fit parameter.

Furthermore, it is found that the thermal conductivity κ_{B} of the bulk gas 6 varies as the absolute temperature T of the gas 6 like κ_{B}∝\sqrt{T} and the mean free path of the gas depends on the absolute temperature T and pressure p, like λ˜T/p. As a result the effective thermal conductivity of the gas phase in the porous microstructure depends on temperature, pressure and pore size according to the relationship (2) below:

$$κ ∝ \sqrt{T} \cdot {( 1 + β \cdot \frac{T}{d \cdot p} )}^{- 1} \qquad ( 2 )$$

where β is an empirical constant, and the other the symbols denote quantities as defined above.

In the illustrated embodiment, the gas 6 is air, which may be approximated to comprise essentially Nitrogen. In such a case, it is found that the effective thermal conductivity of the gas phase in the porous microstructure depends on temperature T of the bulk gas (air), pressure P of the bulk gas, and average pore size d according to the relationship (3) below:

$$κ = 0.0017 \cdot \sqrt{T} \cdot {( 1 + 0.00093 \cdot \frac{T}{d \cdot p} )}^{- 1} \qquad ( 3 )$$

where T is the bulk gas temperature in Kelvin and p the bulk gas pressure in atmospheres.

Based on the above, it is found that a substantial reduction of the thermal conductivity through the gas phase in the porous TBC can be achieved if the average pore size d is limited in accordance with the relationship (4) below.

$$d \leq 0.00093 \cdot \frac{T}{p} \qquad ( 4 )$$

where d is the average pore size in μm,
T is the absolute temperature of the bulk gas (i.e., in Kelvin units), and
p is the pressure of the bulk gas in atmospheres.

In general, it has been found that a significant reduction of the thermal conductivity through the gas phase in the porous TBC if the average pore size d of the porous TBC is limited generally as (5)

$$d \leq 0.001 \cdot \frac{T}{p} \qquad ( 5 )$$

where the symbols denote quantities as defined above.

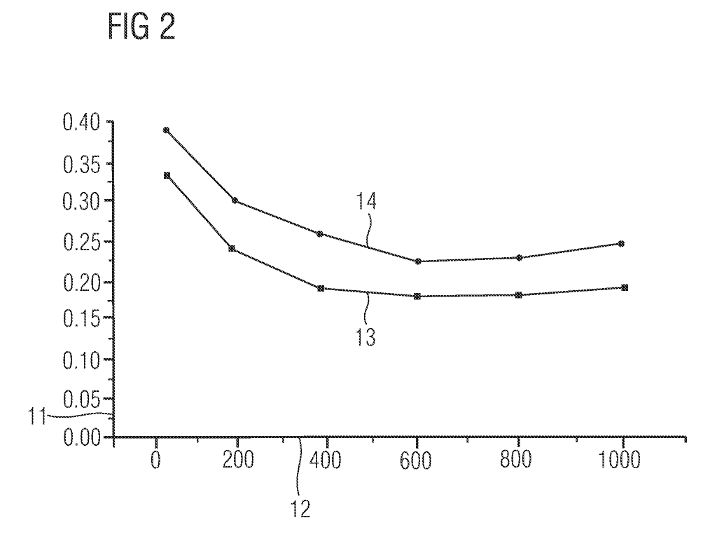

It is known that the thermal conductivity of the gas phase of the porous TBC increases with increase in pressure. This is explained referring to FIG. 2, which is a graph illustrating variation of thermal diffusivity of a typical APS thermal barrier coating (which is proportional to the thermal conductivity of the gas phase of the porous TBC) with temperature of the gas. The thermal diffusivity (mm²/s) is represented along the axis 11 while the temperature (° C.) is represented along the axis 12. The curve 13 represents the variation of thermal diffusivity of the TBC with temperature in vacuum while the curve 14 represents this variation under 1 atmosphere pressure air (or Nitrogen). As shown, an increase in thermal diffusivity, and hence thermal conductivity of the gas phase of the porous TBC, is noted with an increase in pressure. However, by limiting the average pore size of the porous TBC in accordance with the relationship (5) above, it is possible to eliminate or reduce the effect of pressure on the thermal conductivity of the gas phase of the porous TBC.

For typical gas turbine operation conditions (T˜1000° C., p˜10 atm), using the above relationship (5), the average pore size of the porous TBC less than 0.1 μm. As a consequence, an exemplary embodiment of the present invention provides a TBC having a ceramic microstructure, wherein the average pore size below 0.1 μm (100 nm), to achieve improved thermal insulation under typical gas turbine operation conditions. The reduced pore size (in the range <100 nm) will allow to achieve higher efficiency and performance goals of advanced industrial gas turbines. As indicated by a number of experiments, a reduced pore size in the nanometers range allows an additional increase of the overall porosity of the TBC without compromising mechanical integrity of the TBC. This additional porosity increase reduces the heat flow through the solid phase of the TBC, and, therefore, provides an additional improvement of the thermal insulation of the TBC.

Since the pore size is directly correlated to the size of the sprayed powder particles 7, the reduction of the particle size will reduce the pore size significantly. In order to achieve the desired pore size distribution it is desirable to use powder in a lower micron (e.g. ˜0.5 μm) scale and preferably in a submicron (e.g. 30-60 nm) scale.

Summarizing, the inventive principle as proposed herein is to utilize the characteristic length scale of the hot gas mean free path as a characteristic size limit for the pore size of TBC in order to reduce the effective thermal conductivity of TBCs under typical gas turbine operation conditions. Thus, in accordance with the present invention, a metallic article adapted to be exposed to a gas, includes a metallic substrate, and a thermal barrier coating on said metallic substrate for restricting heat transfer from said gas to said metallic substrate. The thermal barrier coating includes a coating of a ceramic material formed by a deposition of powdered particles of said ceramic material defining a porous microstructure, wherein the porous microstructure has an average pore size ‘d’,

$$such that d \leq 0.001 \cdot \frac{T}{p} ,$$

where d is the average pore size in μm,
T is an absolute temperature of the gas, and
P is a pressure of the gas in atmospheres.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined by the below-mentioned patent claims.

1-12. (canceled)

13. A metallic article adapted to be exposed to a gas during operation conditions, the article comprising:
a metallic substrate; and
a thermal barrier coating on the metallic substrate for restricting heat transfer from the gas to the metallic substrate, the thermal barrier coating including a coating of a ceramic material formed by a deposition of a plurality of powdered particles of the ceramic material defining a porous microstructure,
wherein the porous microstructure has an average pore size ‘d’, such that
$$d \leq 0.001 \cdot \frac{T}{p} ,$$
where d is the average pore size in μm,
T is an absolute temperature of the gas, and
p is a pressure of the gas in atmospheres
during operation conditions,
wherein the average pore size is equal to or less than 0.1 μm, and
wherein the plurality of powdered particles have a particle size less than 0.5 μm.

14. The article according to claim 13, wherein the plurality of particles have a particle size less than 100 nm.

15. The article according to claim 13, wherein the plurality of particles have a particle size between 30 nm and 60 nm.

16. The article according to claim 13, wherein the article is a gas turbine component.

17. The article according to claim 13, wherein the ceramic material comprises yttria stabilized zirconia.

18. The article according to claim 13, wherein the thermal barrier coating further includes an oxidation resistant metallic layer deposited directly on to the metallic substrate prior to forming the coating of the ceramic material.

19. A method for forming a thermal barrier coating for a metallic article adapted to be exposed to a gas during operation conditions, the method comprising:
forming a coating of a ceramic material comprising a deposition of a plurality of powdered particles of the ceramic material defining a porous microstructure, wherein the porous microstructure has an average pore size ‘d’, such that
$$d \leq 0.001 \cdot \frac{T}{p} ,$$
where d is the average pore size in μm,
T is an absolute temperature of the gas in Kelvin, and
p is a pressure of the gas in atmospheres,
wherein the average pore size is equal to or less than 0.1 μm.

20. The method according to claim 19, wherein the plurality of powered particles have a particle size less than 100 nm.

21. The method according to claim 19, wherein the plurality of particles have a particle size between 30 nm and 60 nm.

22. The method according to claim 19, wherein the metallic article is a gas turbine component.

23. The method according to claim 19, wherein the ceramic material comprises yttria stabilized zirconia.

24. The method according to claim 19, wherein forming the thermal barrier coating further includes forming an oxidation resistant metallic layer deposited directly on to the metallic substrate prior to forming the coating of the ceramic material.
